(19) United States
(12) Patent Application Publication
(10) Pub. No.: US 2014/0316963 A1
(43) Pub. Date: Oct. 23, 2014

(54) SAVINGS PARTICIPATION RIGHT UNITS WITH INVESTOR DIVERSIFICATION

(71) Applicant: C. H. & I. Technologies, Inc., Santa Paula, CA (US)

(72) Inventor: Lawrence M. Levenstein, Los Angeles, CA (US)

(73) Assignee: C. H. & I. Technologies, Inc., Santa Paula, CA (US)

(21) Appl. No.: 14/212,998

(22) Filed: Mar. 14, 2014

Related U.S. Application Data
(60) Provisional application No. 61/945,428, filed on Feb. 27, 2014.
(60) Provisional application No. 61/789,544, filed on Mar. 15, 2013.

(51) Int. Cl. G06Q 40/04

(52) U.S. Cl. CPC G06Q 40/04
USPC 705/37

(57) ABSTRACT

A method for funding a municipal solid waste reduction program includes conducting a study of anticipated future cost savings for a Municipality from implementing sealable, refillable fluid product packaging to replace existing disposable fluid product packaging for the purpose of reducing solid waste. After the study, one establishes a value for a savings participation right that shares savings generated by replacing the disposable fluid product packaging with sealable, refillable fluid product packaging, and offers for sale the savings participation right to investors based on said established value. The savings participation right holder is paid a monetary value based on actually realized municipal savings resulting from a reduction in solid waste as a consequence of the municipal solid waste reduction program.

This application claims priority from U.S. Application No. 61/945,428, filed Feb. 27, 2014 and U.S. Application No. 61/789,544, filed Mar. 15, 2013 incorporated by reference in its entirety.

### BACKGROUND

Disposable packaging waste (boxes, containers, wrappers, paper, plastic, etc.) accounts for about 30% of the refuse filling current landfills. Landfill disposal costs continue to rise and, at the same time, available landfill space is declining. Municipalities and local governments are paying increased transportation, collection, and disposal costs associated with waste management. As local facilities are closed, waste transportation distances become greater, and associated costs continue to rise.

Recent data shows that Municipal solid waste generated in the U.S. is approximately 430,000,000 tons per year. Because of this, U.S. Municipalities pay approximately $100/ton for collection, processing and disposal of their solid waste, or approximately $43 billion per year. Of this solid waste collected, packaging waste represents almost one third of the total tonnage that is crowding the landfills across the country. Further data suggests that refillable packaging for consumer products can impact approximately twenty percent of this unwanted packaging waste. And of the approximate twenty percent of packaging waste that can be impacted by refillable consumer packaging, this value can be further reduced by approximately eighty percent using sealed and refillable consumer packages. For example, one refillable package of cosmetics can replace up to sixty disposable packages—a ninety eight percent reduction. Moreover, the consumer packaging of the top twenty major consumer fluid product manufacturers (CFPMs) account for approximately eighty percent of consumer packaging. This waste also has a profound impact on the local and global environment. For example, carbon dioxide emissions are reduced approximately two metric tons per ton of solid waste elimination.

Certain new refillable packaging technologies, including among them a system called PERFECTFLOW® offered by CHI Technologies, Inc., provides consumers with a reusable package that eliminates single-use, disposable consumer packaging. Using this technology, Municipalities can expect a reduction in collection, processing and disposal costs associated with solid waste. Municipalities would enjoy the fruits of such waste reduction plans for years, and the problems of creating and locating more landfills would be alleviated by such plans.

However, implementing these waste reduction programs using refillable fluid containers could cost hundreds of millions of dollars in outlays of capital before municipalities begin to reap the benefits of the programs. Once the programs are operational and fully performing, the savings can reach based on current estimates up to nine hundred million dollars a year. Municipalities do not always have the resources to implement such a program, even though the savings will be realized in a relatively short time frame. One option for such municipalities is to offer bonds to the public to pay for such urban improvements. However, bonds in some investment environments are not always attractive to many investors. The problem thus becomes how to fund the solid waste reduction programs in order to get the systems in place, whereupon the savings can begin to be realized going forward as a revenue stream. The present invention addresses this issue.

CFPMs predominantly use sealed, non-refillable packaging, such as plastic tubes, jars, bottles, and the like. Once the non-refillable packaging is empty, it is thrown away and a new product is purchased to replace it. Each individual disposable package is hermetically sealed to, among other things, mitigate the risk of product tampering. For a CFPM to use refillable consumer packaging, the refillable consumer packaging container must be capable of material exchange while sealed. The current difficult economic environment prevents CFPM brand managers from receiving approval to introduce refill programs using sealed and refillable packaging without the following three questions being answered:

1. Will their customers participate in their refill programs?

2. Can their organization accommodate the changes in supply chain logistics demanded by refillable consumer packaging?

3. Is there a business case?

Municipalities' current desire for additional funds at a time of federal and municipal fiscal constraints encourages them to sell rights to future streams of savings; in this case, a share of the future stream of the savings from source reduction of solid waste. The present invention is directed to a solution to allow funding of environmentally friendly packaging through investment opportunities by offering rights to participate in the future savings that refillable packaging will bring.

### SUMMARY OF THE INVENTION

The present invention offers financial solutions to fund a specific activity that generates savings for Municipalities using a program called Savings Participation Rights (SPRs). An SPR is a right to a specified share of certain savings generated as a result of a specific activity; in this instance the use of refillable packaging technology for solid waste source reduction. An SPR agreement entitles the buyer of an SPR to a specified share in the savings generated by a specific activity, e.g., source reduction in solid waste management, and, where such savings are documented by an independent agent, who may be paid by escrowed funds from the sale of such SPRs.

To illustrate by way of example, the amount of money received by Los Angeles, Calif., as a result of the sale of such SPRs is estimated to be approximately $530,000 on an SPR sale (SPR share). Additionally, if the project is successful, Los Angeles receives up to $747,000 per year (12% of the annual savings) for the 15-year term (interim municipal share) plus up to $6 million per year (100% of the savings) thereafter (post-program municipal share); i.e., approximately $530,000 on the sale of SPRs plus up to $9 million (12% of term savings) plus up to $6 million per year (100% of the savings) thereafter, excluding inflation and population growth.

Furthermore, Los Angeles could sell such SPRs pursuant to an SPR Agreement. The SPR Agreement specifies the terms and conditions of the sale; including, but not limited to, the monthly distribution per SPR, the number of SPRs, the price per SPR, the agent to document and report savings, the method to calculate such monthly savings, the due date for such agent to report monthly savings, the documentation fee to be paid per report, and other documentation reporting and audit requirements. Such savings are documented independently, where such independent documentation may be paid from SPR funds reserved and perhaps escrowed contemporaneously with the sale of such SPRs.

The current project is to demonstrate (a) that consumers will use sealed and refillable consumer packaging, (b) that consumer product manufacturers are able to use sealed and refillable packaging profitably, and (c) that such manufacturers are able to manage the new logistics attendant to such packaging. The project includes the installation of CFPM specific refill stations in retail locations and the distribution of CFPM specific sealed and refillable consumer packaging to be refilled at such refill stations.

To implement such a program, a series of tests may be proposed and carried out. The tests can include the following milestones:

1. Demonstration of a prototype refill system (refill station, refill cartridge, and refill bottle) by a set date, such as for example day fifteen of project; where such refill bottle is at least 50 ml and such refill station is able to automatically refill such refill bottle.

2. Development of retail-ready refill systems (refill stations, compatible refill cartridges, compatible refill bottles, warehouse refill stations, and refill intermediate bulk containers (refill IBCs)) suitable for certain CFPMs, where such refill systems are both sealed and refillable. The refill stations refill the refill bottles, the refill cartridges refill the refill stations, the warehouse refill stations refill the refill cartridges, and the refill IBCs refill the warehouse refill stations.

3. Specification of the metrics for evaluating such refill systems, including but not limited to impacts on solid waste management.

4. Measurement of the performance of refill systems against specified metrics.

5. Delivering a written report documenting results.

6. How-to books covering the new logistics attendant to refillable packaging.

After documentation fees and payment of the underwriting and marketing fees, the net amount of funds available for the project using present day numbers is about $290 million. Using this program, the feasibility of selling SPRs to fund a Municipality solid waste source reduction program can be implemented.

In one preferred embodiment of the present invention, various SPRs are bundled and sold together as savings participation rights units (SPRUs). Municipalities would tend to benefit from such bundling, to prevent investors from cherry picking the most attractive opportunities and leaving less attractive opportunities. Where various projects can be sold as units of an overall plan, greater diversity of investment can be achieved along with a more universal investment base.

As a first example, if there are ten scheduled projects, SPRs can be offered that include a return of investment based on the overall profitability of the ten projects, rather than offering investors a choice of individual projects. As a second example, if there are 273 Municipalities participating in a specific program, SPRUs can be offered that include a return on investment based on the participation in the solid waste management savings accruing to such 273 Municipalities, rather than offering investors a choice of individual Municipality SPRs. This simplifies the underwriting process, and reduces the number of offerings tenfold or 273 fold, respectively. This also ensures that the least attractive opportunities or Municipality SPRs will still be funded or purchased on the same level as the more attractive projects or Municipality SPRs.

The Municipality can also sell a portion of its share of the anticipated proceeds as part of the funding process. By selling the present value of the future stream savings, the program can be funded faster and the Municipality can reduce or eliminate the uncertainty in the venture. A Municipal Term Savings from the SPR (“MTSSPR”) is an option where the Municipality has rights to a twelve percent (12%) share of the savings from a specific SPR program, with a term of fifteen years. Prior to the expiration of the term, the municipality can opt to sell its rights in the savings stream. The underwriter acting for such Municipality sells such MRSSPRs to investors at a price that is acceptable to investors based on the present value of the future savings. The proceeds are delivered to the investor, on terms acceptable to the parties, less the fees of the underwriter.

To illustrate by way of the example cited in 0008, herein, if the project is successful, Los Angeles, Calif., receives up to $747,000 per year (12% of the annual savings) for the 15-year term (interim Municipal share). After a project startup period of say two (2) years, the Municipality can sell its MTSSPR for the remaining SPR term (13 years) to investors for $6,600,000—i.e., $747,000 for 13 years discounted to present value at 6%.

The Municipality not only has an option to sell the unexpired future savings stream, but can also sell to investors the post-program savings using the present value of the anticipated future savings. This Municipal After Term Savings from the SPR (“MATSSPR”) can involve the one hundred percent ownership of the post term savings, extending as long into the future as an annuity as the parties can agree. The underwriter acting on behalf of the Municipality sells the MATSSPRs to investors at a price commensurate with the present value of the future savings, less the underwriters fees.

To illustrate by way of the example cited in 0008, herein, if the project is successful, Los Angeles, California, receives up to $6 million per year in savings from the project upon expiration of the 15-year term of the SPRs. Assuming the Municipality decides to sell the next thirty (30) years of this income stream of $6 million per year, the Municipality can sell its MATSSPRs to investors for $82 million—i.e., $6 million for 30 years discounted to present value at 6%.

In this manner, municipalities can either hold an interest in the future savings that will be derived from reduction in solid waste as a result of funding and implementing a refillable, reusable sealable fluid container and refill system for consumer products within that Municipality.

I Claim:

1. A method for funding a municipal solid waste reduction program comprising the steps of:
conducting a study of anticipated future cost savings for a Municipality from implementing sealable, refillable fluid product packaging to replace existing disposable fluid product packaging for the purpose of reducing solid waste;
establish a value for a savings participation right that shares savings generated by replacing the disposable fluid product packaging with sealable, refillable fluid product packaging, and offering for sale the savings participation right to investors based on said established value;
providing refill stations that refill fluid products using the sealable, refillable, fluid product packaging to reduce solid waste generated by disposable fluid product packaging; and
pay a savings participation right holder a monetary value based on actually realized municipal savings resulting from a reduction in solid waste as a consequence of the municipal solid waste reduction program.

2. The method for funding a municipal solid waste reduction program of claim 1, wherein said refill stations are located in retail locations.

3. The method for funding a municipal solid waste reduction program of claim 1, further comprising a step of preparing a savings participation right agreement prior to offering for sale the savings participation right to investors, where the savings participation right agreement includes a monthly distribution per savings participation right.

4. The method for funding a municipal solid waste reduction program of claim 1, further comprising a step of preparing a savings participation right agreement prior to offering for sale the savings participation right to investors, where the savings participation right agreement includes a number of savings participation rights available.

5. The method for funding a municipal solid waste reduction program of claim 1, wherein multiple savings participation rights from multiple solid waste reduction programs are bundled together and sold as a savings participation rights unit.

6. The method for funding a municipal solid waste reduction program of claim 1, wherein the study of anticipated future cost savings includes a demonstration of a prototype refill station.

7. The method for funding a municipal solid waste reduction program of claim 6, further comprising a step of developing retail-ready refill systems including refill stations, compatible refill cartridges, compatible refill bottles, and intermediate bulk containers.

8. The method for funding a municipal solid waste reduction program of claim 7, further comprising a step of specifying metrics for evaluating a performance of such retail ready refill systems, including an impact of the retail ready refill system on a reduction of the generation of solid waste.

9. The method for funding a municipal solid waste reduction program of claim 1, wherein a Municipality retains an interest in a future savings resulting from the solid waste reduction program.

10. The method for funding a municipal solid waste reduction program of claim 9, wherein the Municipality sells at a present value an interest in a future stream of savings to investors based on the municipal solid waste reduction program.

11. The method for funding a municipal solid waste reduction program of claim 10, where the Municipality sells its retained interest in a future savings corresponding to a term of the program at a present market value (MRSSPR).

12. The method for funding a municipal solid waste reduction program of claim 10, where the Municipality sells its retained interest in a future savings corresponding to an after-term of the program at a present market value (MATSSPR).
